(19) United States
(12) Patent Application Publication
(10) Pub. No.: US 2009/0272765 A1
(43) Pub. Date: Nov. 5, 2009

(54) Tip-stop mechanism, pump-type product with tip-stop mechanism, and aerosol-type product with tip-stop mechanism

(75) Inventors: Masaaki Seki, Tokyo (JP); Masato Suzuki, Tokyo (JP)

Correspondence Address: LUCAS & MERCANTI, LLP, 475 PARK AVENUE SOUTH, 15TH FLOOR, NEW YORK, NY, 10016, US

(73) Assignee: MITANI VALVE CO., LTD., Chiyoda-ku, TOKYO (JP)

(21) Appl. No.: 12/094,510

(22) PCT Filed: Jun. 8, 2006
(86) PCT No.: PCT/JP2006/311499

§ 371 Date: Jun. 25, 2008

(30) Foreign Application Priority Data
Nov. 22, 2005 (JP) PCT/JP2005/021437

(51) Int. Cl. B65D 88/54; B67D 5/40; B65D 83/00

(52) U.S. Cl. 222/321.3; 222/375; 222/380; 222/402.12

(57) ABSTRACT

The tip-stop mechanism for an aerosol container has a needle valve placed into a passage area and closes discharge hole due to plate springs engagement with tapered surfaces of the needle valve. An operation lever is supported on a pivot shaft and when pressed downward forces a portion of the lever to cause the needle valve to move backward, opening the discharge hole. After that, the operation lever engages the upper surface of the spout and moves downward together with the spout and the stem, thereby the lever is shifted to an operation mode.

### TECHNICAL FIELD OF THE INVENTION

The present invention relates to a tip-stop mechanism capable of preventing a content remaining in a passage region located in the vicinity of a discharge outlet from leaking out of the discharge outlet to an external space by closing the discharge outlet when discharge operation of the content in a container body is finished, i.e., capable of preventing hardening in a pump type container and outer draw in an aerosol type container, and also relates to a pump type product and an aerosol type product equipped with the tip-stop mechanism.

In the present specification, the side of the discharge outlet is assumed to be “front” while the opposite side thereto assumed “rear”. That is, a left side direction in FIG. 1 is assumed to be “front” and a right side direction “rear”.

The term “pump type” in the present specification indicates a system where a volume of a content accommodation space is reduced by permitting a user to press for example an operation part or part of a container such as a peripheral surface part and a content therein is discharged to an external space. This is a concept including a push-out type and a tube type.

Contents, to which the present invention is applied, include varieties of articles as described later, starting with liquid or cream like soaps, shampoos, conditioners, cosmetics, expandable shaving foams, and hair styling foams for example.

### BACKGROUND OF THE INVENTION

A tip-stop mechanism, actively intending to prevent content hardening and deal with outer draw, is disclosed in Japanese Unexamined Patent Application Publication No. 2001-171764 for example described below.

The tip-stop mechanism substantially comprises
an operation button (cover),
a spout for content passage united with a container body side stem,
a horizontal (direction perpendicular to a moving direction of the operation button) type nozzle mounted on the spout
valve members (2 pieces) disposed in an internal space of the nozzle, and
an elastic body for energizing the valve member in a direction where the discharge outlet on the nozzle tip end side is closed.

Herein, an action piece to the valve member is formed in the operation button, and a receiving part of one end of the elastic body is formed in the spout.

The operation button (cover) is configured to block a valve member rear end side, so that the button, when the operation thereof changes from a stationary mode to an actuation mode by the operation of the operation button, receives and holds a valve member rear end side going back via the action piece during the operation. In the stationary mode and in the middle of changing to the actuation mode from the stationary mode the rear end side of the valve member has been separated from the receiving part of the operation button (cover).

The valve member moves rearwardly against energizing force of the elastic body following the content discharge operation, whereby the content discharge outlet is set to the open state (actuation mode).

When the content discharge operation is finished, the valve member returns to the initial state i.e. a blocked state of the content discharge outlet (=stationary state) by the energizing force of the elastic body.

Prior art tip-stop mechanism are convenient in view of response at the time of starting and ending of its discharge of any content as described above.

They however have drawbacks that when the sheath-shaped operation button (cover), nozzle, valve member, spout or the like are made integral into a tip-stop mechanism, there is needed a slightly complicated work of covering the cover for example from an upper side of the nozzle and valve member extending laterally such as the foregoing longitudinal direction to a vertical direction such as lower direction. The movement between the cover and the nozzle in the integrating work and the valve member is of course relative.

For this there are needed the improvements or the like that integration works among the cover, nozzle, and valve member should be more effective and that a vertical slit formed in a cover front surface could otherwise be eliminated or not be formed such that a front protruded part of the nozzle passes the cover at the time of the integration.

### OBJECTS OF THE INVENTION

In the present invention, open regions are formed by opening the upper surface part of the spout and in the rear side peripheral wall part, and a rear side part of the valve member in the downstream cylindrical part (=downstream side passage reaching the discharge outlet to an external space of the spout) is exposed, and the exposed part is held from its rear part while undergoing elastic force to the forward by a cover structure (peripheral wall cover structure) of the peripheral wall opening part, and further operation members of a rotary type and a vertical type disposed in the upper surface open region of the spout are employed. The spout used here indicates the mode including the foregoing nozzle.

It is an object of the present invention to make effective and simple assembling work of a tip-stop mechanism by enabling a valve member to be assembled into a downstream cylindrical part of a spout from a rear surface side thereof in the state where the cover is not mounted on the rear side peripheral wall opening part, and further mounting the operation member of the foregoing each type for actuation mode setting into the open region (concave part) of the spout upper surface.

It is another object of the present invention to make further effective the assembling work and reduce costs of products by reducing the number of components of the entire tip-stop mechanism by integrally forming an elastic member for energizing the valve member frontally on the peripheral wall cover in the form of a leaf spring, and further integrally forming the spout and the operation member of the rotary type.

It is further another object of the present invention to make smooth the vertical movement of the operation member itself at the time of the pressing operation of the operation member and at the time of releasing of the pressing operation by providing a leaf spring on a leg part guided to an internal peripheral surface part of a peripheral wall e.g., a recessed part constituting the open region or on a downstream cylindrical part of the spout, the leaf spring making contact with the leg part of the downstream cylindrical part from above thereof, for the operation member of the vertical movement type mounted in the open region in the upper surface of the spout.

### SUMMARY OF THE INVENTION

These and other objects are obtained by the tip-stop mechanism, in which a discharge outlet (e.g., discharge holes 1h, 11h, 21h, 31h described later) provided on a front side thereof undergoes initial setting to a closed state owing to the action of elastic force and changes from a closed state up to that time to an open state based on the content discharge operation of a user. Broadly,
(1) the present invention is designed as a tip-stop mechanism comprising:
   1. a spout (e.g., spout 1, 11, 21, 31 described later) including a downstream cylindrical part constituting a linear downstream passage (e.g., longitudinal passage 1f, 11f, 21f, 31f described later) reaching said discharge outlet, an upstream cylindrical part constituting an upstream passage (e.g., vertical passage 1e, 31e described later) leading to an output part (e.g., stem 5 described later) on the side of a container body, a peripheral wall part with the downstream passage opened at a rear extension part thereof, and an upper surface open region (e.g., open region 1a, 11a, 21a, 31a described later);
   2. a valve member provided (e.g., needle valve 2, 12, 22 described later) movably on the downstream passage for implementing opening/closing operation with respect to said discharge outlet;
   3. a peripheral wall cover (e.g., peripheral rear cover 3, 13, 23 described later) mounted on the opening part of the peripheral wail section of said spout for supporting a rear exposed section side of the valve member;
   4. an elastic member (e.g., leaf spring 3b, 23b and coil spring 15 described later) provided on the side of said peripheral wall cover for energizing said valve member in a front direction where said discharge outlet is closed; and
   5. an operation member (e.g., operation member 4, 14, 24, and operation button 34 described later) disposed in an upper surface opening region of the spout for moving the valve member rearwardly, by making part thereof act on a rear exposed part of said the member following setting operation of the actuation mode.
(2) in (1) as the elastic member there is used a first lead spring formed on the peripheral wall cover body (e.g., peripheral wall cover 3, 23 described later) is used.
(3) in (2) as the first leaf spring (e.g., leaf spring 3b, U-shaped leaf spring 23b described later) there is used one (e.g., U-shaped leaf spring 23b described later) integrally formed with the valve member (e.g., needle valve 22 described later) and the peripheral wall cover body (e.g., peripheral wall rear cover 23 described later).
(4) in (1) as the elastic member a coil spring (e.g., coil spring 25 described later) separated from the peripheral wall cover (e.g., peripheral wall rear cover 13 described later) is used.
(5) in (1) to (4) as the operation member one (operation lever 4, 14, 24 described later) of a rotary type is used.
(6) in (5) as the operation member of the rotary type there is used one (e.g., operation lever 24 described later) formed integrally, in the state where a rotation base part (e.g., hinge-shaped part 24a described later) of the operation member is coupled with the spout (e.g., spout 21 described later) in front of the upper surface open region (e.g., open region 21a described later).
(7) in (1) to (4), as the operation member there is used one (e.g., operation member 34 described later) of a vertical movement type.
(8) in (7) as the operation member of the vertical movement type there is used one including a leg part (e.g., fractional part 34c, 34d described later) moving vertically in accordance with the guide part (e.g., guide recessed part 34c, 34d described later) formed on the internal peripheral surface of the peripheral surface part, and a second leaf spring (e.g., leaf spring 34a described later) making contact with (abutting on) the outer peripheral surface (e.g., upper outer peripheral surface 31g described later) of the downstream cylindrical part from above thereof and displaced in the form resisting elastic force of itself at the time of lowering movement of the operation member associated with the setting operation of the operation mode.

The tip-stop mechanism described above, and an aerosol type product and a pump type product both including the tip-stop mechanism are objects of the present invention.

### EFFECT OF THE INVENTION

In accordance with the present invention, as described above, the valve member can be assembled into the downstream cylindrical part from a rear surface side thereof in the state where the cover is not mounted on the peripheral wall opening part, and also for the operation mode for operation mode setting only the rotary shaft may be mounted on the upper surface opening part of the spout so that it is possible to make effective and simple the assembling work of the tip-stop mechanism.

The operation member for operation mode setting is disposed in the upper surface opening region set inside the peripheral wall part of the spout, so that there is eliminated the need of the foregoing vertical slit that is an essential component in the case of the conventional operation member.

The elastic member for energizing the valve member frontally is formed integrally on the peripheral wall cover in the form of a leaf spring and the spout and the rotary type operation member are integrally formed, so that it is possible to reduce the number of components of the whole tip-stop mechanism and so make more effective the assembling work and reduce the costs of products.

The legs guided to the internal peripheral surface part of the peripheral wall part constituting the upper surface open region of the spout and the leaf spring abutting on the downstream cylindrical part of the spout from above thereof are provided on the vertical movement type operation member, so that it is possible to make smooth the vertical movement of the operation member itself at the time of pressing operation of the operation member and at the time of releasing of the pressing operation.

### BRIEF DESCRIPTION OF THE DRAWINGS

These and other aspects of the present invention may be more fully understood by reference to one or more of the following drawings:

FIG. 1 is views, each in cross sectional state, illustrating a tip-stop mechanism using an operation member of a rotary type (first case) in (a) a stationary mode or (b) an actuation mode (embodiment 1);

FIG. 2 is a view illustrating a relationship among respective components (4) of the tip-stop mechanism of FIG. 1 (embodiment 1);

FIG. 3 is a view illustrating a relationship among components (5) of the tip-stop mechanism using an operation member of a rotary type (second case) (embodiments 2);

FIG. 4 is a view illustrating a relationship between components (2) of the tip-stop mechanism using an operation member of a rotary type (third case) (embodiment 3);

FIG. 5 is views, each in cross section, illustrating a tip-stop mechanism using an operation member of a vertical type (a) in stationary mode and (b) in actuation mode (example 4); and

FIG. 6 is a view illustrating a relationship among components (4) of a chip stop mechanism of FIG. 5 (embodiment 4).

### DESCRIPTION OF REFERENCE CHARACTERS

The following components indicated by reference numbers each with an alphabet (e.g., vertical passage 1a) denote parts of those without alphabet (e.g., spout 1).

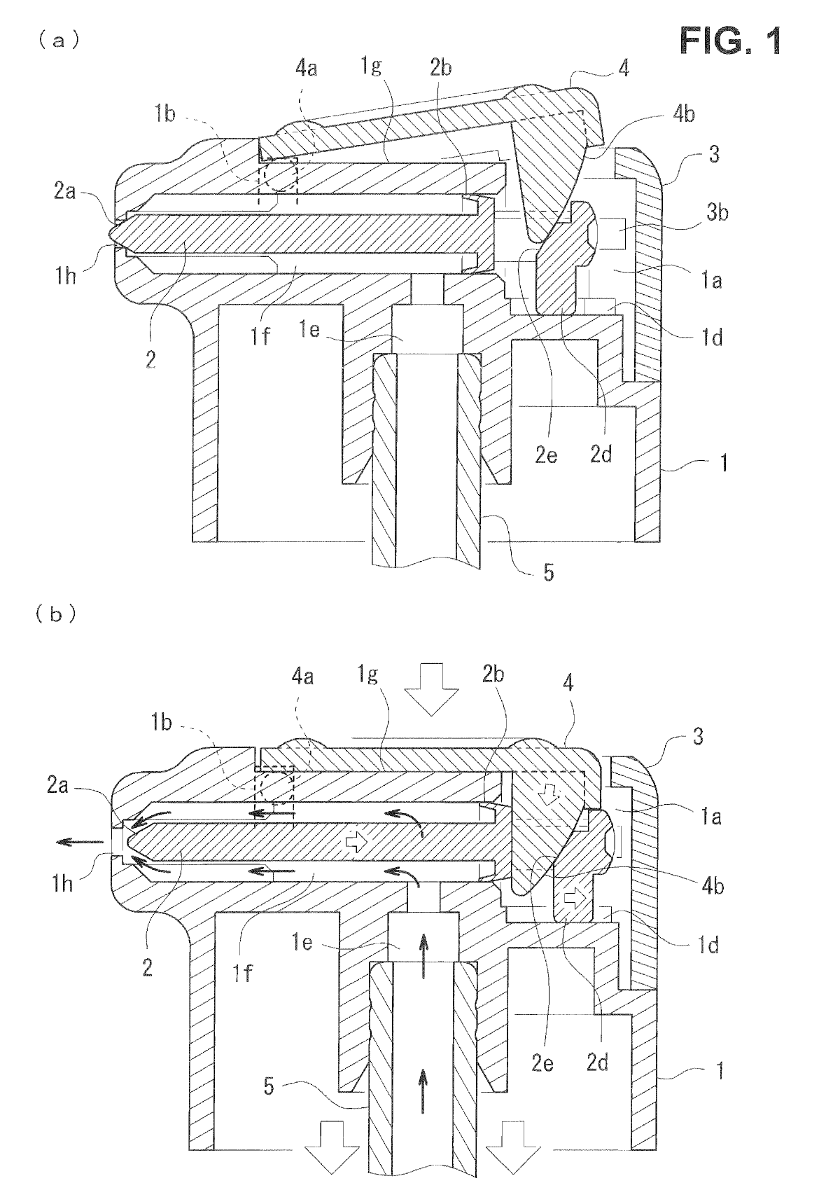

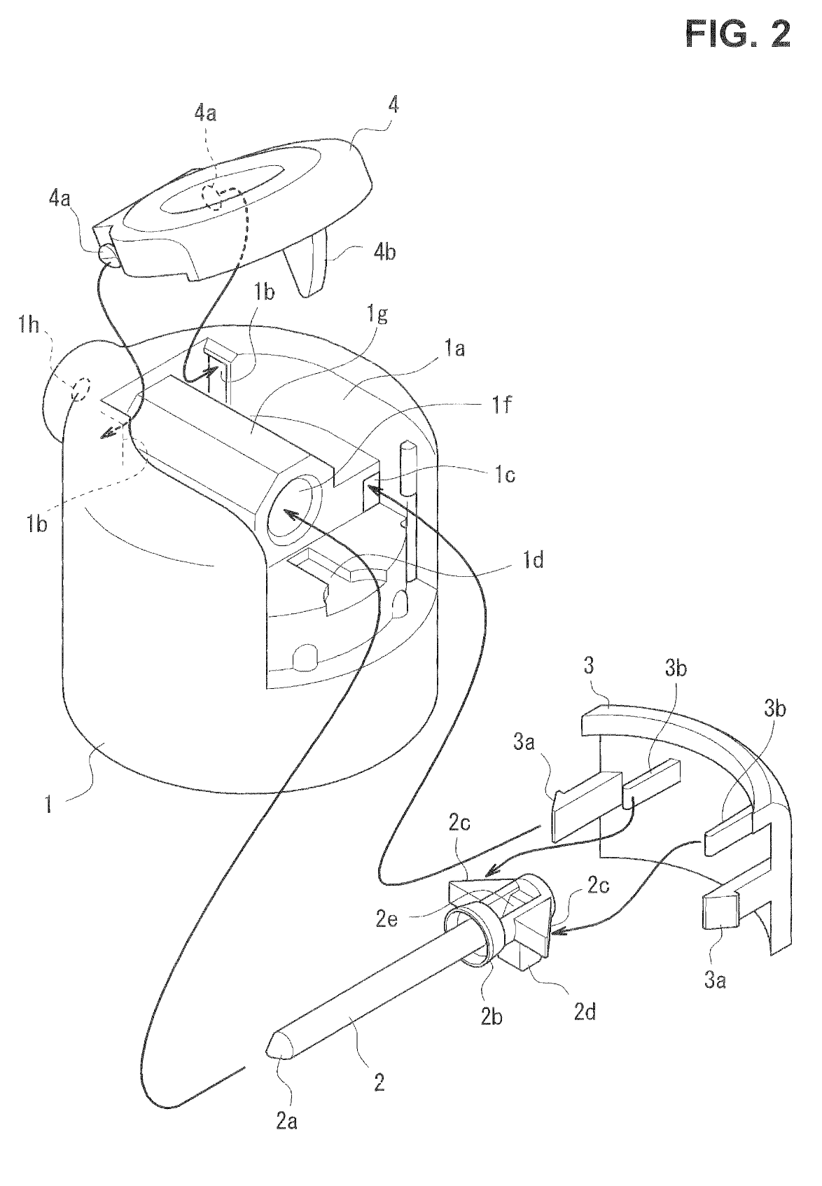

Further, 1 digit reference numbers (1 to 5) are employed in FIGS. 1 and 2;

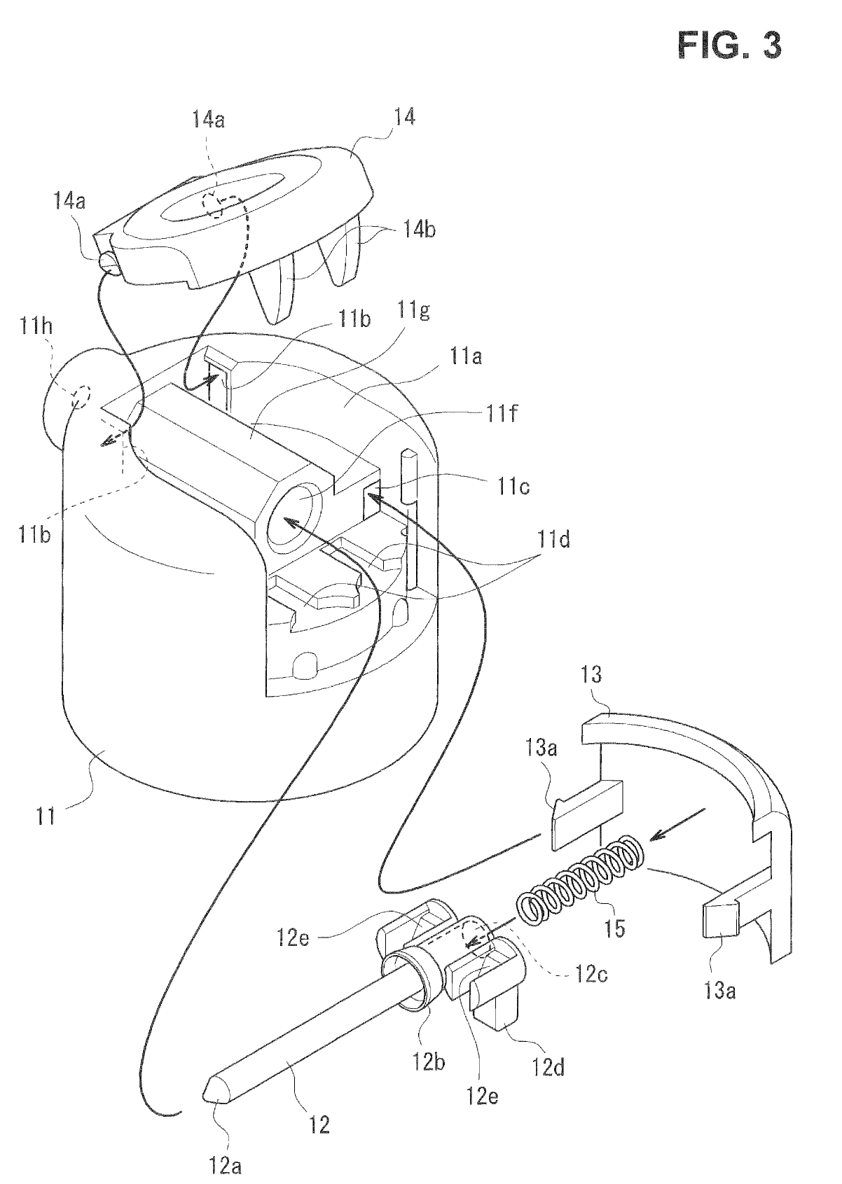

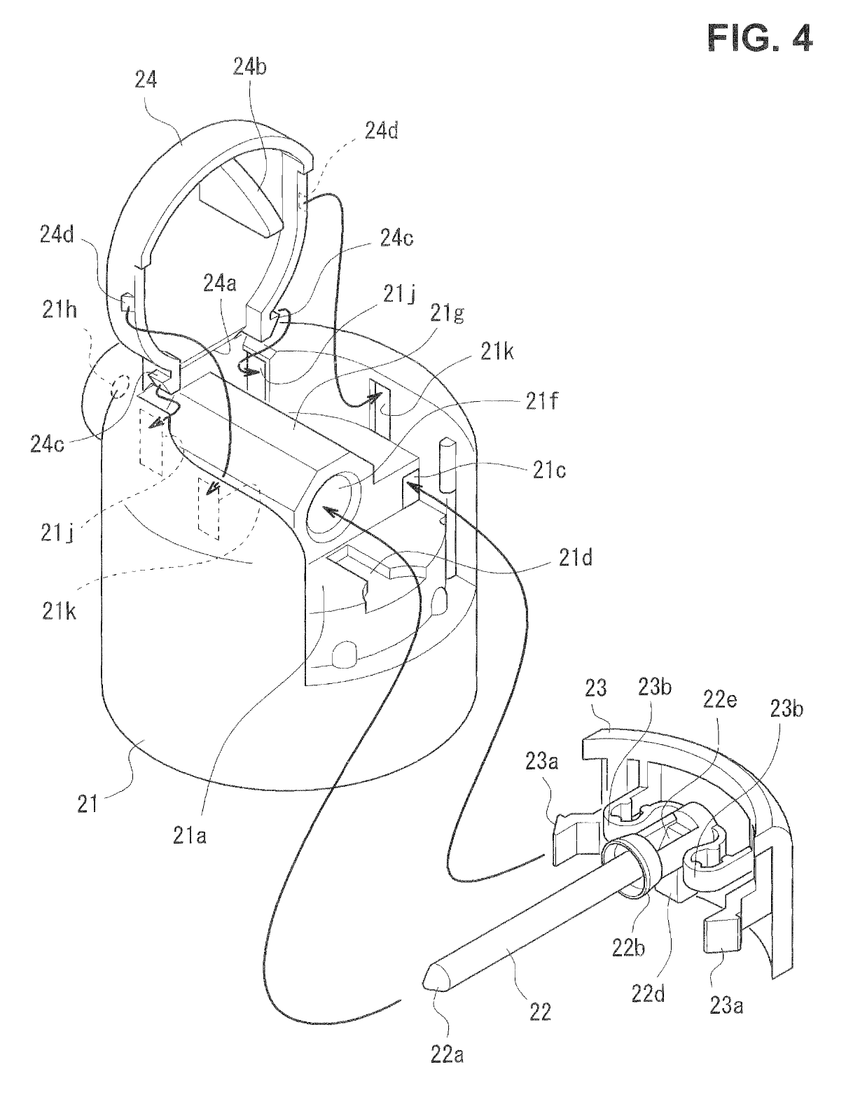

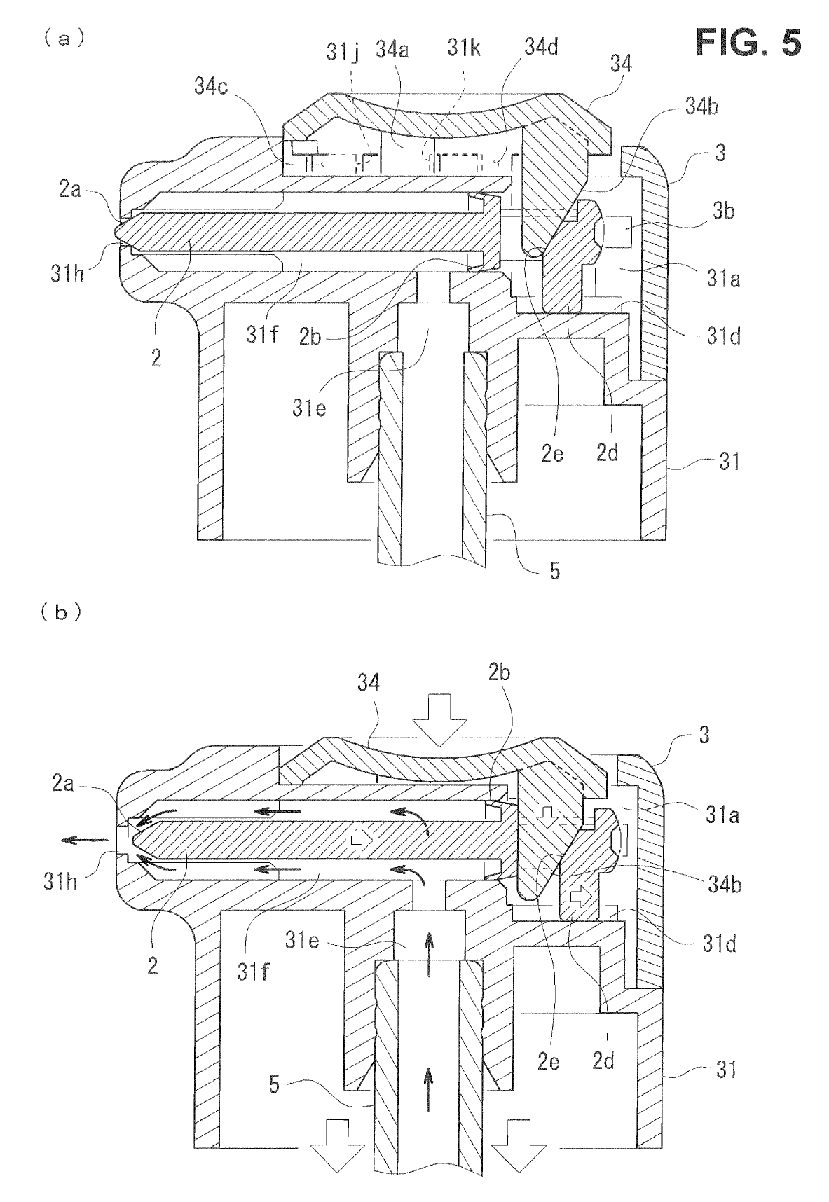

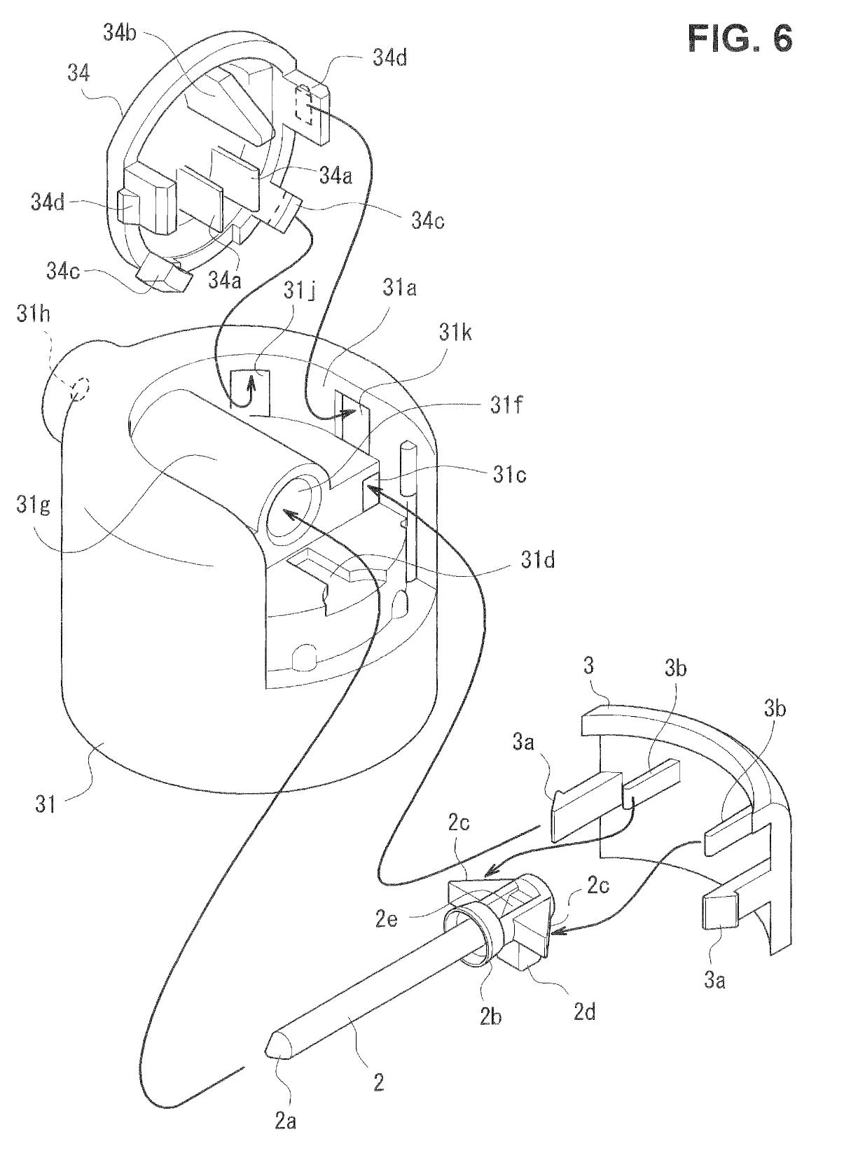

There are employed 11th to 15th reference numbers in FIG. 3;
21th, to 24th in FIG. 4; and there are employed 31th to 34th in FIGS. 5 and 6, with reference numbers 2, 3 employed in FIGS. 5 and 6.

The following numbers 1, 11, 21, 31 and those with alphabet concern the spout respectively.
1, 11, 21, 31: spout mounted on (fitted to) a stem 5 on the side of a container body described later;
1a, 11a, 21a, 31a: a recessed open region extending from the upper surface of the spout to a rear side peripheral surface;
1b, 11b: a pair of recessed parts formed in a front side peripheral surface of the open region 1a, 11a for supporting a rotary shaft of an operation lever 4, 14 described later;
1c, 11c, 21c, 31c: a pair of recessed parts formed at an erected surface part of a rear side step part of the open region 1a, 11a, 21a, 31a for engageably holding a peripheral wall rear part cover 3, 13, 23 described later;
1d, 21d, 31d: a single groove part formed on a surface part in a rear side step part longitudinal direction of the open region 1a, 21a, 31a for guiding needle valve 2, 22 (lower protruded part 2d, 22d) described later;
11d: a pair of groove parts formed on a surface part of the open region 11a in a rear side step part longitudinal direction for guiding a needle valve 12 (lower protruded part 12d) described later;
1e, 31e: a cylindrical vertical passage constituting an upstream side of a content passage space region of the spout 1, 31;
1f, 11f, 21f, 31f: a cylindrical longitudinal passage (nozzle equivalent part) constituting a downstream side leading to a vertical passage; 1g, 11g, 21g: a cylindrical upper side outer peripheral surface (flat plane part) constituting the longitudinal passage 1f, 11f, 21f;
31g: a cylindrical upper side outer peripheral surface (curved part) constituting the longitudinal passage 31f;
1h, 11h, 21h, 31h: a discharge hole formed at a front end part on the longitudinal passage 1f, 11f, 21f;
21j, 21k: a pair of guide recessed parts for holding rotatably an operation lever 24 after assembled described later between its stationary mode and actuation mode; and
31i, 31k: a pair of guide recessed parts for holding the operation button 34 vertically movably between the positions in the stationary mode and actuation mode.

The following reference numbers 2, 12, 22 with and without alphabet concern a needle valve.
2, 12, 22: a needle valve disposed to enter a longitudinal passage 1f, 11f, 21f, 31f of the spout 1, 11, 21, 31;
2a, 12a, 22a: a conical part formed on the tip end of the needle valve to act as a valve of a discharge hole 1h, 11h, 21h, 31h;
2b, 12b, 22b: an annular sealing part located in close contact with the internal peripheral surface of the longitudinal passage 1f, 11f, 21f, 31f for preventing any content in the passages from leaking to a rear side;
2c: a pair of tapered faces formed at needle valve rear side part (rear side part from the annular sealing part) exposed from the longitudinal passage 1f, 31f and abutting on a leaf spring 3b described later;
12c: a sheath-shaped part formed at the needle valve rear side part exposed from the longitudinal passage 11f to accommodate a front end of a coil spring 15 described later;
2d, 22d: a single lower protruded part formed at a needle valve rear side part exposed from the longitudinal passage 1f, 21f, 31f to move along a groove part 1d, 21d, 31d of the spout 1, 21, 31;
12d: a pair of lower protruded parts formed at the needle valve rear side part exposed from the longitudinal passage 11f to move along the groove part 11d of the spout 11;
2e, 22e: a single tapered receiving part formed on an upper surface part of the downward protruded part 2d, 22d for converting a movement (turning or downward movement) of an operation lever 4, 24 described later to a linear movement in a front direction of the needle valve 2, 22 by a receiving part (single piece 4b, 24b, 34b) of the operation lever 4, 24 and of the operation button 34;
12e: a pair of tapered receiving parts formed on the upper surfaces of a pair of downward protruded parts 12d for converting a movement (rotation) of an operation lever 14 described later to a linear movement in a front direction of a needle valve 12 by receiving part (a pair of pieces 14b) of the operation lever 14.

The following reference numbers 3, 13, 23 with and without alphabet concern a peripheral wall rear cover.
3, 13, 23: peripheral wall rear part cover
3a, 13a, 23a: a pair of legs (tapered face plus engaging step part) engaged and held by the recessed part 1c, 11c, 21c, 31c of the spout 1, 11, 21, 31;
3b: a pair of flat face leaf springs abutting on the tapered face 2c of the needle valve for energizing the valve in a front direction;
23b: a pair of U-shaped leaf springs integrally formed with the needle valve 22b and the peripheral wall rear part cover 23 for energizing the valve in a front direction.

The following reference numbers 4, 14, 24 with and without alphabet concern the operation lever illustrated in FIGS. 1 to 4.
4, 14, 24: operation lever of a rotary type
4a, 14a: a pair of rotary shafts
24a: a hinged part, a connection part between the spout 21 and the operation lever 24 serving as a rotation base part upon the lever operation;
4b, 24b: a single piece for driving needle valve abutting on the receiving part 2e, 22e of the needle valve 2, 22 after assembled for releasing a closed state between discharge holes 1h, 21h and the conical parts 2a, 22a up to that time by moving the valve backward when the operation levers 4, 24 are rotated (upon setting operation of the actuation mode);
14b: a pair of pieces for driving the needle valve 12 backward upon the rotation operation of the operation lever 14;
24c,24d: a pair of pieces (tapered face plus engaging step part) formed at an illustrated portion on the outer peripheral surface of the operation lever 24 and held rotatably in a guide recessed part 21j, 21k of the spout 21 upon assembling by turning the lever clockwise in the figure.

The following reference number 34 with or without alphabet concerns the operation button in FIGS. 5 and 6.
34: operation button of vertical movement type;
34a: a pair of hung leaf springs abutting on an upper outer peripheral surface (curved part) 31g of the spout 31 at its end side, guided by the curved part following the actuation mode setting (downward movement) to displace to the outside resisting own elastic force;
34b: a needle valve driving single piece abutting on the receiving part 2e of the needle valve 2 after assembled by moving the valve backward upon depressing operation of the operation button 34 for releasing a closed state (stationary mode) between the discharge hole up to that time and the conical part;
34c, 34d: a pair of pieces (tapered face plus engaging step part) formed at an illustrated portion on the outer peripheral surface of the operation button 34 and held enabling depressing operation into the guide recessed parts 31j, 31k of the spout when the button is pushed and assembled into the open region 31a of the spout 31 from above

Reference numbers 5, 15 are used for other components.
5: a stem fitted to the spouts 1, 11, 21, 31 and including a well known valve mechanism element to the container body side (e.g., a discharge valve in case of a pump type product a discharge valve; in case of an aerosol type product, a content passage hole part closed by an annular rubber in the stationary mode);
15: a coil spring disposed between the sheath-shaped part 12c of the needle valve 12 and the internal peripheral surface of the peripheral wall rear cover 13 for energizing the valve in a front direction.

The spout 1, 11, 21, 31, needle valve 2, 12, 22, peripheral wall rear cover 3, 13, 23, operation lever 4, 14, 24, operation button 34, and stem 5 etc. are made of plastic consisted of polypropylene, polyethylene, polyacetal, nylon, for example. The coil spring 15 is made of metal or plastic.

Fundamental features of each illustrated tip-stop mechanism (embodiments 1 to 4) are substantially as follows:
(11) The spout body part fitting to the stem 5 on the container body side and the nozzle equivalent part for accommodating the needle valve 2, 12, 22 are constructed in the form of the spout 1, 11, 21 composed of an integral molded product.
(12) When mounting the needle valve 2, 12, 22 and the peripheral wall rear cover 3, 13, 23 on the spout 1, 11, 21, the needle valve is loaded into the longitudinal passage (nozzle equivalent portion) 1f, 11f, 21f of the spout from the rear thereof, and then the peripheral wall rear cover (in case of FIG. 3, after a front end side of the coil spring 15 is put into the sheath-shaped part 12c of the needle valve 12) is loaded from the rear of the needle valve;
(13) The operation lever 4, 14, 24 is mounted rotatably in the open region 1a, 11a, 21a of the spout, and the operation button 34 is disposed vertically movably in the open region 31a of the spout 31 in which each piece 4, 14, 24, 34 thereof abuts on the tapered receiving part 2e, 12e, 22e of the needle valve 2, 12, 22 in the stationary mode.
(21) The number of the components of the tip-stop mechanism in FIGS. 1 and 2 is 4: spout 1; needle valve 2; “peripheral wall rear cover 3 plus leaf spring 3b”, and operation lever 4.
(22) The number of the components of the tip-stop mechanism in FIG. 3 is 5: spout 11; needle valve 12; peripheral wall rear cover 1; operation lever 14; and coil spring 15.
(23) The number of the components of the tip-stop mechanism in FIG. 4 is 2: “spout 21 plus operation lever 24”; “needle valve 22 plus peripheral wall rear cover 23 plus leaf spring 23”.
(24) The number of components of the tip-stop mechanism in FIGS. 5 and 6 is 4: spout 31; needle valve 2; “peripheral wall rear cover 3 plus leaf spring 3b”, and operation button 34.

Any of the following components in total 12 is an integral molded product: spout 1, needle valve 2, “peripheral wall rear cover 3 plus leaf spring 3b”, operation lever 4 in FIGS. 1 and 2; spout 11, needle valve 12, peripheral wall rear cover 13, an operation lever 14 in FIG. 3; “spout 21 plus operation lever 24”, “needle valve 22 plus peripheral wall rear cover 23 plus leaf spring 23 in FIG. 4; spout 31, needle valve 2, “peripheral wall rear cover 3 plus leaf spring 3b”, and operation button 34 in FIGS. 5 and 6.

### DETAILED DESCRIPTION OF THE INVENTION

Preferred embodiments of the present invention will be described with reference to the accompanying drawings.

### Embodiment 1

An assembling procedure of the tip-stop mechanism illustrated in FIGS. 1 and 2 is as follows, for example.
(31) The needle valve 2 is loaded to the longitudinal passage 1f of the spout 1 from the rear thereof.
(32) After the loading of the needle valve, a pair of the leg parts 3a of the peripheral wall rear cover 3 are put into a pair of the recessed parts 1c of the spout 1 from the backward and engaged therewith.
(33) A pair of the rotary shafts 4a of the operation lever 4 are immersed into a pair of the recessed parts 1b on the front side of the spout 1.
(34) The spout 1 is fitted to the stem 5.

Upon the pair of the legs 3a of the peripheral wall rear cover 3 being inserted into the recessed part 1c of the spout 1, the legs first abut along its tapered surface on the rear spout internal peripheral surface of the recessed part and go forward resisting own elastic force while displacing inwardly a little, respectively. Once the rear end of the tapered surface (=a transition part to the engaging step part) moves up to the recessed part 1c, the displacement part to the inside up to that time is restored elastically to permit the engaging step part of the leg parts 3a to be clamped by the recessed part 1c.

Also upon the pair of the rotary shafts 4a of the operation lever 4 being immersed into the front side recessed part 1b of the spout 1, the rotary shafts are compressed a little abutting first on the spout peripheral surface and resisting own elastic force, and compressed parts up to that time are restored elastically and are held by the recessed part once they advance to the recessed part 1b.

The order of the foregoing works (31) to (34) is arbitrary under the restriction that the mounting work (32) of the peripheral wall rear cover 3 or the mounting work (33) of the operation lever 4 is performed after the finish of the loading work (31) of the needle valve 2

In case of the tip-stop mechanism (stationary mode) after the assembling in FIGS. 1 and 2,
(41) the downward protruded part 2d of the needle valve 2 is guided to the single groove part 1d of the spout 1,
(42) the leg part 3a (engaging step part thereof) of the peripheral wall rear cover 3 is engaged and held by the recessed part 1c of the spout 1,
(43) the needle valve 2 abuts along the tapered face 2c on the tip end inner surface part of the leaf spring 3b of the peripheral wall rear cover 3 to be energized frontally by elastic force of the leaf spring,
(44) with the energization action the discharge hole 1h of the spout 1 is closed at the conical part 2a of the needle valve 2, and
(45) the operation lever 4 permits its rotary shaft 4a to be held by the recessed part 1b of the spout and the tip end rear curved part of its piece part 4b to be made to abut on the receiving part 2e of the needle valve 2.

The operation lever 4 at this time is separated from the upper outer peripheral surface 1g of the spout 1 as illustrated in FIG. 1(a), and also its piece part 4b simply rides the receiving part 2e of the needle valve 2.

Once a user presses downward the upper surface of the operation lever 4, first the operation lever is turned clockwise in the figure around the rotary shaft 4a, permitting also the piece part 4b, part of the operation lever to be turned in the same direction.

Following the turning of the piece 4b backward force acts on the receiving part 2e of the tapered face of the needle valve 2, permitting the needle valve to move backward widening outward the pair of the leaf springs 3b with the tapered faces 2c against respective energizing forces of the springs. Owing to the backward motion of the needle valve 2 the conical part 2a thereof is separated from the discharge hole 1h of the spout 1 and the discharge hole changes from the closed state up to that time to an open state.

The turning state of the operation lever 4 (fractional part 4b) carries on until the lower surface part of the operation lever makes contact with the upper outer peripheral surface 1g of the spout 1.

Once the operation lever 4 abuts on the spout 1 (upper outer peripheral surface 1g), both members move integrally downward together with the stem 5 resisting upward elastic force of the well known stem energizing coil spring (not shown) and change to the actuation mode. More specifically, with the downward movement of the stem 5 the known valve action part of the stem becomes an open state and a content accommodated in the container flows out to the outer space after passage through “open state valve action part—stem 5—vertical passage 1e of the spout 1—longitudinal passage 1f—discharge hole 1h”.

Although following the turning of the fractional part 4b also downward force acts on the receiving part 2e of the tapered face of the needle valve 2, energizing force of the leaf spring 3b to the needle valve 2 (tapered face 2c) is not strongly set as upward energizing force of the coil spring (not shown) to the stem 5 so that the spout 1 and the stem 5 do not first move downward although the needle valve 2 does not yet retire.

As setting means of the actuation mode there may be used a well known mechanism, e.g., in case of the pump type product a mechanism that closes an upstream lower valve (suction valve) and opens a downstream side upper valve (discharge valve) and in case of the aerosol type product a mechanism that displaces the position of the stem hole part with respect to the stem gasket to make the hole part a communication state. The foregoing stem energizing coil spring is also well known.

Once a user stops the pressing of the operation lever 4, the entire of the stem 5, spout 1, and the entire of the operation lever (keeping its state abutting on the upper outer peripheral surface 1g of the spout) moves upward to a predetermined position owing to the action of the stem energizing coil spring (not shown) to close the valve action part of the stem. The discharge operation for a container content is thus finished.

The predetermined position is a stationary mode position of the stem 5 which is uniquely defined depending on a relevant structure between a movable stem side and a fixed container side.

Together with returning operation of the stem 5 to the stationary mode position, the needle valve 2 receives forward force via the tapered face 2c by restoring action of the leaf spring 3b of the peripheral wall rear cover 3 to the inside and moves in the same direction. As a result, the discharge hole 1h to the external space is closed by the conical part 2a of the needle valve to make the operation return to the stationary mode in FIG. 1(a).

### Embodiment 2

Main differences between components in a tip-stop mechanism in FIG. 3 and those in FIGS. 1 and 2 are as follows:
(51) A coil spring 15 is used instead of the leaf spring 3b in FIGS. 1 and 2.
(53) pair of grooves 1d are formed in a rear flat plane of the spout 11 for respectively guiding a lower protruded part 12d of a needle valve 12.
(52) A sheath-shaped part 12c is formed at a rear end central part of the needle valve 12 for accommodating the coil spring 15.
(54) A pair of the lower protruded parts 12d guided to a groove part 11d of a spout 11 and a pair of receiving parts 12e for response to the operation lever.
(55) A pair of fractional part 14b abutting on the receiving parts 12e of the needle valve 12 are formed on the operation lever 14.

The restriction of the assembling procedure of the tip-stop mechanism is that the needle valve 12 is loaded to the longitudinal passage 11 of the spout 11 and the coil spring 15 is inserted into a sheath-shaped part 12c of the needle valve 12 and then a leg part 13a of a peripheral wall rear cover 13 is mounted on a recessed part 11c of the spout 11.

Relevant structures among components such as the spout 11, needle valve 12, peripheral wall rear cover 13, operation lever 14, and stem (not shown) for example, movement modes of the spout 11, needle valve 12, and operation lever 14 accompanying the changeover operation between the stationary mode and the actuation mode, relationships between the strength of the coil spring 15 used instead of the leaf spring 3b and the strength of the upward energizing coil spring (not shown) of the stem or the like excepting the above constitution are the same as in the case of the tip-stop mechanism in FIGS. 1 and 2.

### Embodiment 3

Main differences between components in a tip-stop mechanism in FIG. 4 and those in FIGS. 1 and 2 are as follows:
(61) A spout 21 and an operation lever 24 are integrally molded, and both members are connected by a hinge-shaped part 24a that is a turning base part of the operation lever 24.
(62) A needle valve 22 and a peripheral wall rear cover 23 are integrally molded via a pair of U-shaped leaf springs 23b. The needle valve 22 is movable frontally against the rear energizing force of the U-shaped leaf spring 23b in response to the turning operation of the operation lever 24 (setting operation of the actuation mode).
(63) The operation lever 24 includes a pair of protruded fractional parts 24c, 24d (tapered face plus engaging step) formed thereon and the spout 21 includes correspondingly a pair of guide recessed parts 21j, 21k. In the state of the tip-stop mechanism after assembled, the protruded fractional parts 24c, 24d are held by the guide recessed parts 21j, 21k. In the holding state after assembled, the protruded fractional parts 24c, 24d are movable (turnable) in the guide recessed parts 21j, 21k, e.g., in the stationary mode the engaging step of the protruded fractional part is engaged with an inner surface part of the guide recessed part

The restriction in the assembling procedure of the tip-stop mechanism is that after a leg part 23a of the peripheral wall rear cover 23 is fitted in a recessed part 21c of the spout 21, the operation lever 24 in the illustrated state is turned clockwise to permit protruded fractional parts 24c, 24d thereof to enter guide recessed parts 21j, 21k of the spout 21.

In the process where the protruded fractional parts 24c, 24d of the operation lever 24 are made to enter the guide recessed parts 21j, 21k, tapered faces of the protruded fractional parts 24c, 24d are once deformed and then restored to an original state as in the case of the pair of the legs 3a (13a, 23a) of the peripheral wall rear cover where they are mounted to the spout.

More specifically, the tapered faces of the protruded fractional parts 24c, 24d first abut on a spout internal peripheral surface part where the guide recessed parts 21j, 21k have not been formed and are deformed to the inside. The tapered faces are restored elastically to original shapes by entering the guide recessed parts 21j, 21k as a whole.

Relevant structures among the components such as the spout 21, needle valve 22, peripheral wall rear cover 23, operation lever 24, stem (not shown) or the like; moving modes among the spout 21, needle valve 22, and operation lever 24 accompanying changeover operation between the stationary mode and the actuation mode; a relationship between the strength of the U-shaped leaf spring 23b and the upward energizing coil spring of the stem (not shown); and so on, excepting the aforementioned structure are the same as in the case of the tip-stop mechanism in FIGS. 1 and 2.

### Embodiment 4

Main differences between components in a tip-stop mechanism in FIGS. 5 and 6 and those in FIGS. 1 and 2 are as follows:
(71) As the operation member for actuation mode setting there is used a vertical movement type operation button 34 that includes a pair of hung leaf springs 34a and a pair of fractional parts to be guided (tapered face plus engaging step) 34c, 34d.
(72) An upper outer peripheral surface 31g of a spout 31 is made a curved shape; upon pressing-down operation of the operation button 34 a pair of leaf springs 34 are displaced to the outside along the curved surface resisting own elastic force; and guide recessed parts 31j, 31k are formed for individually guiding fractional parts (tapered face and engaging step part) 34c, 34d of an operation button 43 upon vertical movement of the same.
(73) The operation button 34 and the spout 31 are united integrally by pushing the operation button 34 into an open region 31a of the spout 31 from an upper portion thereof.

Fractional parts (tapered face plus engaging step part) 34c, 34d of the operation button are restored to an original state by permitting them to be once deformed to the inside upon pushing-in operation and to enter the guide recessed parts 31j, 31k of the spout 31.

More specifically, the fractional parts 34c, 34d, that are being pushed in from a peripheral surface part of the guide recessed parts 31j, 31k of the spout 31 located just thereabove are first deformed inside as a whole by permitting tapered faces thereof to abut on (against some own elastic force because of its being made of synthetic resin) the peripheral surface, and are then elastically restored to an original state by permitting them to enter the guide recessed part. In this restored state, the fractional parts 34c, 34d are engaged with the guide recessed parts 31j, 31k.

In the operation button 34 assembled finally, the pair of the leaf springs abut on the upper outer peripheral surface 31g of the spout 31 such that they are displaced outside a little, and a single fractional part 34b for driving needle valve abuts on the receiving part 2e of the needle valve 2. The pair of the leaf springs 34a are formed symmetrically with respect to a central line that passes through a fractional part 34b of the top surface of the operation button 34.

The operation button 34 is supported by the spout 31 with good balance at the pair of the leaf springs 34a and at a single fractional part 34b and is positioned peripherally of the spout 31 at the fractional parts 34c, 34d. The pair of the leaf springs 34a are slightly displaced outside so that the operation button 3 is energized upward with elastic force of the leaf spring 34a to prevent unnecessary backlash.

It is noticed that as the operation button 34 is pressed, the fractional parts 34c, 34d are moved downward, guided to the guide recessed parts 31j, 31k of the spout 31.

Following the downward movement of the operation button, in the same manner as in the case of the operation levers in FIGS. 1 to 4,
(81) By first permitting the single fractional part 34b of the operation button to act on the receiving part 2e of the needle valve 2 until the top surface of the operation button 34 abuts on the upper outer peripheral surface 31g of the spout 31 (at this time, the leaf spring 34a is deformed outside along the upper outer peripheral surface), the needle valve is driven backward in the form of resisting own elastic force of the leaf spring 3b to release a closed state of the discharge hole 31h up to that time by the conical part 2a;
(82) After the top surface abuts on the upper outer peripheral surface 31g (refer to FIG. 5(b)), the spout 31 united integrally with the operation button 34 moves downward to open the well known stem valve mechanism (not shown);
(83) As a result, a content accommodated in the container is discharged to the external space after passage through “stem 5—vertical passage 31g of the spout 31—the longitudinal passage 31f of the spout 31—discharge hole 31h. That is, the operation is set to the actuation mode.

Elastic force of the pair of the leaf spring 34a deformed outside along the upper outer peripheral surface 31g of the spout 31 in pressing-down operation of the operation button 34 is set enough smaller than that of a well known coil spring (not shown) for stem energization as in the leaf spring 3b for needle valve energization.

When the user releases the pressing (actuation mode) of the operation button 34,
(91) the spout 31 is restored to the stationary mode position by the action of the coil spring (at this time, the operation button 34 keeps substantially abutting on the upper outer peripheral surface 31g of the spout i.e. the needle valve 2 goes back for the discharge hole 31h to keep being open).
(92) Then, the needle valve 2 is restored frontally by elastic force to the tapered face 2c of the pair of the leaf spring 3b. Following this, the operation button 34 returns upwardly vertically by forces acting on two positions: the elastic force of the pair of the leaf spring 34a and force acting on the fractional part 34b by the receiving part 2e of the needle valve 2, and changes to the stationary mode.

The restriction in the assembling procedure of the tip-stop mechanism in FIGS. 5 and 6 is that the needle valve 22 is loaded to the longitudinal passage 31f of the spout 3 and then the operation button 34 and the peripheral wall rear cover 3 is mounted on the spout.

Relevant structures among components of the spout 31, needle valve 2, peripheral wall rear cover 3, and stem (not shown), and moving modes between the spout 31 and the needle valve 12 accompanying the changeover operation between the stationary mode and the actuation mode for example, excepting the aforementioned structure are the same as in the tip-stop mechanism in FIGS. 1 and 2.

There may be used a tip-stop mechanism in the mode where the spout 21 and the operation lever 24 in FIG. 4 are replaced with the spout 1 and the operation lever 4 in FIGS. 1 and 2 and a tip-stop mechanism in the mode where the needle valve 22 and the peripheral wall rear cover 23 in FIG. 4 are replaced with the needle valve 2 and the peripheral wall rear cover 3.

There may be used a method of integral molding between the spout 21 and the operation lever 24 as integration between the spout 1 and the operation lever 4 in the tip-stop mechanism in FIGS. 1 and 2 and as integration means between the spout 11 and the operation lever 14 in the tip-stop mechanism in FIG. 3.

Further, instead of the fractional part 34b (for driving the needle valve), needle valve 2, and peripheral wall rear cover 3, the corresponding components in FIGS. 3 and 4 may be properly employed or in combination thereof.

### Embodiment 5

Aerosol type products and pump type products to which the present invention is applicable include various applications such as cleansing agents, cleaning agents, antiperspirants, coolants, muscle antiphlogistic agents, hair styling agents, hair treatment agents, hair washing agents, hair restorers, cosmetics, shaving foams, foods, droplet like products (such as vitamin), medical goods, quasi drugs, coating materials, gardening agents, repellant agents (insecticides), cleaners, deodorants, laundry starch, urethane foams, extinguishers, adhesives, lubricant agents or the like.

Contents accommodated in the container body include powdery products, oil components, alcohols, surfactants, high polymers, and effective components associated with various applications.

Powdery products includes metal salts powder, inorganic powder, and resin powder or the like, e.g. talc, kaolin, aluminum hydroxychloride (aluminum salt), calcium arginate, powdered gold, silver powder, mica, carbonate, barium sulphate, cellulose, and mixtures of them.

Oil components include silicone oil, palm oil, eucalyptus oil, camellia oil, olive oil, jojoba oil, paraffin oil, myristic acid, palmitic acid, stearic acid, linoleic acid, linolenic acid or the like.

Alcohols include monovalent lower alcohol such as ethanol, monovalent higher alcohol such as lauryl alcohol, and multivalent alcohol such as ethylene grycol or the like.

Surfactants include anionic surfactant such as sodium laurylsulphate, non-ionic surfactant such as polyoxiethylene oleyl ether, amphoteric surfactant such as lauryl dimethyl amino acetic acid betaine, and cationic surfactant such as alkylchloride trimethylammonium or the like.

Polymer molecule compounds include methylcellulose, gelatine, starch, and casein or the like.

Effective components associated with respective applications include antiphlogistics/analgesics such as methyl salicylate and indometacin, bactelia elimination agents such as sodium benzoate and cresol, harmful insect extermination agents such as pyrethroid, diethyltoluamide, anhidrotics such as zinc oxide, algefacient such as camphor and peppermint camphor, antiasthmatic agents such as ephedrine and adrenaline, edulcorant such as sucralose and aspartame, adhesive and paint such as epoxy resin and urethane, dyes such as paraphenylenediamine and aminophenol, and extinguishant such as ammonium dihydrogenphosphate and sodium/potassium acid carbonate or the like.

Further, there are usable suspensions, UV absorbers, emulsifiers, humectants, antioxidants, and metal ion blocking agents, etc.

Content discharge gas in the aerosol type product includes carbon dioxide, nitrogen gas, compressed air, oxygen gas, lean gas, compressed gas of mixed gas etc. of the former gases, liquefied petroleum gas, and liquefied gas of dimethyl ether and fluorocarbon etc.

1. A tip-stop mechanism, in which a discharge outlet provided on a front side thereof undergoes initial setting to a closed state owing to the action of elastic force and changes from a closed state up to that time to an open state based on the content discharge operation of a user, comprising:
a spout including a downstream cylindrical part constituting a linear downstream passage reaching said discharge outlet, an upstream cylindrical part constituting an upstream passage leading to an output part on the side of a container body, a peripheral wall part with the downstream passage opened at a rear extension part thereof, and an upper surface open region;
a valve member provided movably on the downstream passage for implementing opening/closing operation with respect to said discharge outlet;
a peripheral wall cover mounted on the opening part of the peripheral wall section of said spout for supporting a rear exposed section side of the valve member;
an elastic member provided on the side of said peripheral wallcover for energizing said valve member in a front direction where said discharge outlet is closed; and
an operation member disposed in an upper surface opening region of said spout for moving said valve member rearwardly, by making part thereof act on a rear exposed section of said valve member following setting operation of the actuation mode.

2. A tip-stop mechanism according to claim 1 wherein a first lead spring formed on said peripheral wall cover body is used as said elastic member.

3. A tip-stop mechanism according to claim 2 wherein said first leaf spring is integrally formed with said valve member and said peripheral wall cover body.

4. A tip-stop mechanism according to claim 1 wherein as said elastic member a coil spring separated from said peripheral wall cover is used.

5. A tip-stop mechanism according to any of claim 1 wherein as said operation member a rotary type is used.

6. A tip-stop mechanism according to claim 5 wherein said operation member of the rotary type is formed integrally, in the state where a rotation base part of the operation member is coupled with said spout in front of said upper surface open region.

7. A tip-stop mechanism according to claim 1 wherein as said operation member a vertical movement type is used.

8. A tip-stop mechanism according to claim 7 wherein said operation member of the vertical movement type includes a leg part moving vertically in accordance with the guide part formed on the internal peripheral surface of the peripheral surface part, and a second leaf spring making contact with (abutting on) the outer peripheral surface of said downstream cylindrical part from above thereof and displaced in the form of resisting own elastic force upon lowering of the operation member accompanying the setting operation of the actuation mode.

9. A pump type product comprising: a tip-stop mechanism according to claim 1 and accommodating a content in the container body.

10. An aerosol type product comprising: a tip stop mechanism according to claim 1 and accommodating the discharge gas and a content in the container body.
